(19) United States
(12) Patent Application Publication
(10) Pub. No.: US 2012/0077403 A1
(43) Pub. Date: Mar. 29, 2012

(54) MULTILAYER CONDUCTIVE FIBER AND METHOD FOR PRODUCING THE SAME BY COEXTRUSION

(75) Inventors: Patrice Gaillard, Hagetaubin (FR); Alexander Korzhenko, Pau (FR); Philippe Poulin, Talence (FR); Nour Eddine El Bounia, Orthez (FR)

(73) Assignees: Centre National De La Recherche Scientifique, Paris Cedex 14 (FR); Arkema France, Colombes (FR)

(21) Appl. No.: 13/320,959

(22) PCT Filed: May 27, 2010
(86) PCT No.: PCT/FR2010/051026

§ 371 Date: Dec. 14, 2011

(30) Foreign Application Priority Data
May 27, 2009 (FR) 0953507

(51) Int. Cl. B32B 27/02; D02G 3/04; D01D 5/253; D03D 15/00; D04H 13/00; D02G 3/36; D01D 5/34; B82Y 30/00

(52) U.S. Cl. 442/200; 428/373; 428/367; 428/366; 264/172.15; 264/172.12; 442/364; 977/742; 977/734

(57) ABSTRACT

The present invention relates to a multilayer conductive fiber having a core/shell structure, wherein the core contains nanotubes, in particular carbon nanotubes. The invention also relates to a method for producing said fiber by coextrusion and to the uses thereof The invention finally relates to a composite material including the aforementioned multilayer composite fibers bonded together by weaving or using a polymer matrix.

The present invention relates to a multilayer conductive fiber, of core/shell structure, the core of which includes nanotubes, in particular carbon nanotubes. It also relates to a process for the manufacture of this fiber by coextrusion and to its uses. Finally, it relates to a composite material comprising such multilayer composite fibers bonded to one another by weaving or using a polymer matrix,

Carbon nanotubes (or CNTs) are known and have specific crystalline structures, of hollow and closed tubular form, composed of atoms regularly arranged as pentagons, hexagons and/or heptagons, obtained from carbon. CNTs are generally composed of one or more coaxially wound graphite sheets. A distinction is thus made between Single Wall Nanotubes (SWNTs) and Multi-Wall Nanotubes (MWNTs).

CNTs are commercially available or can be prepared by known methods. Several processes exist for the synthesis of CNTs, in particular electrical discharge, laser ablation and Chemical Vapor Deposition (CVD), which makes it possible to provide for the manufacture of a large amount of carbon nanotubes and thus their production at a cost price compatible with their large-scale use. This process consists specifically in injecting a carbon source at relatively high temperature onto a catalyst which can itself be composed of a metal, such as iron, cobalt, nickel or molybdenum, supported on an inorganic solid, such as alumina, silica or magnesia. The carbon sources can comprise methane, ethane, ethylene, acetylene, ethanol, methanol, indeed even a mixture of carbon monoxide and hydrogen (HIPCO process).

CNTs have numerous outstanding properties, namely electrical, thermal, chemical and mechanical properties. Mention may in particular be made, among their applications, of composite materials intended in particular for the automobile, nautical and aeronautics industries, electromechanical actuators, cables, resisting wires, chemical detectors, the storage and conversion of energy, electron emission displays, electronic components and functional textiles. In the automobile, aeronautics and electronics industries, conductive fillers, such as CNTs, make possible the thermal and electrical dissipation of the heat and electrical dissipation of the heat and electricity accumulated during frictional actions.

Generally, when they are synthesized, CNTs are in the form of a disorganized powder composed of entangled filaments, which makes them difficult to employ. In particular, for making use of their mechanical and/or electrical properties on the macroscopic scale, it is necessary for the CNTs to be present in large amounts and oriented in a favored direction.

One of the solutions in overcoming this problem consists in preparing composite fibers. For this, the nanotubes can be incorporated in a matrix, such as an organic polymer. Spinning can then be carried out according to conventional technologies, such as described in particular in EP-1 181 331, which makes it possible, by drawing and/or shearing operations, to orientate the CNTs on the axis of the fiber and to thus obtain the desired mechanical and/or electrical properties. However, this technique requires that the CNTs be very pure and that the aggregates, which the latter, due to their integral structure, naturally have a tendency to form, be removed. This is because these aggregates are harmful to the spinning process and frequently result in breaking of the composite fibers obtained.

Furthermore, the conductivity of the composite fibers obtained according to the abovementioned technique is not always satisfactory. This is because the electrical properties of CNTs improve in proportion as the CNTs are homogeneously and randomly dispersed, whereas spinning processes result, on the contrary, in a high orientation of the CNTs.

In order to overcome this disadvantage, it has been envisaged to deposit CNTs by the solvent route on a preformed fiber. However, when these composite fibers are used to manufacture fabrics, themselves stacked in several lavers in order to form structural, components or brake disks used in the aerospace field or in the auto-mobile field, for example, the frictional action of these components in the air or on the ground causes wearing of the fibers. This results in a loss of CNTs to the atmosphere, the environmental impact of which may prove to be problematic, and a possible deterioration in the mechanical properties of the component.

Yet another route for manufacturing composite fibers based on CNTs has consisted in coagulating a dispersion of CNTs in a flow of polymer, such as poly(vinyl alcohol) (FR 2 805 179). This coagulation process does not however, make it possible to achieve the high spinning rates conventionally used today. This is because it is difficult to stabilize the coflow of the dispersion of CNTs and of the coagulating solution, due to the change from laminar conditions to turbulent conditions at high speed, and also the fragility, in a viscous medium, of the freshly coagulated fibers.

The need thus remains to have available a composite fiber exhibiting good mechanical properties, in particular a high tensile modulus under load and a high tenacity, and optionally good properties of thermal and/or chemical resistance, while having a sufficient conductivity to allow it to dissipate electrostatic charges, even at a low content of nanotubes. The need also remains to have available a stable and economic process for the manufacture of this fiber, at high speed, which is not greatly influenced by the presence of nanotube aggregates.

The Applicant Company has discovered that this need can be met by multilayer fibers, of core/shell structure, the core of which comprises a dispersion of CNTs. These fibers are manufactured in particular by coextrusion of two polymer matrices based on thermoplastic polymer, one of which includes the CNTs.

Admittedly, the suggestion has already been made to manufacture conductive composite fibers by coextrusion of polymer matrices, one of which, forming the core of the fiber, includes conductive fillers and the other, forming the shell of the fiber, comprises a thermoplastic polymer which confers tensile properties on the fiber. To the knowledge of the inventors, this process has, however, only been applied to carbon black (see in particular U.S. Pat. No. 3,803,453 and U.S. Pat. No. 5,260,013). In point of fact, the drawing treatments advantageously employed to enhance the mechanical properties of conductive composite fibers and described in particular in the document EP 1 183 331 are not applicable to this type of fiber. This is because, during these drawing operations, the network of carbon black particles is disrupted, that is to say their contact points are substantially reduced, which negatively affects the conductivity of the fiber. The inventors have observed that this phenomenon does not occur in the case of nanotubes, in particular CNTs.

Furthermore, a description has been given of conductive fibers having a core/shell structure, optionally obtained by coextrusion, comprising carbon nanotubes. In the document EP 1 559 815, these fibers comprise a primary component forming the core and a secondary component forming the shell. Only the secondary component includes CNTs. In the document US 2006/019079, the conductive fibers are composed of a core including a first dispersion of CNTs and a shell including a second dispersion of CNTs. In the document WO 2009/053470, the conductive material, such as CNTs or carbon black, is present only in the shell of the conductive fiber.

It has now been found that the absence of nanotubes in the shell of a multilayer conductive fiber makes it possible to avoid the release of these nanotubes during operations resulting in surface abrasion of the fiber (in particular during weaving or knitting), without, however, negatively affecting the interfiber conductivity, which is provided by heating above the glass transition temperature during the forming thereof.

A subject matter of the present invention is thus a multilayer conductive fiber, comprising:
a core composed of a first polymer matrix including at least one thermoplastic polymer and a dispersion of nanotubes of at least one chemical element chosen from the elements from Groups IIIa, IVa and Va of the Periodic Table, said nanotubes being capable of providing thermal and/or electrical conduction,
a shell composed of a second polymer matrix including at least one thermoplastic polymer other than poly vinyl alcohol) and not comprising a dispersion of nanotubes of at least one chemical element chosen from the elements from Groups IIIa, IVa, and Va of the Periodic Table.

It is specified, as a preliminary, that, throughout this description, the expression “of between” should be interpreted as including the limits mentioned.

The term “fiber” is understood to mean, within the meaning of the present invention, a filament having a diameter of between 100 mm and 10 mm, advantageously between 100 nm and 3 mm, preferably between 1 μm and 3 mm and more particularly between 1 and 100 μm.

According to one embodiment of the invention, the core of the fiber forms a solid structure. In an alternative form, it can however, define a hollow structure. Furthermore, this structure may or may not be porous. With regard to its use, a fiber is intended to ensure the stability of a mechanical component and to strengthen it and is thus distinguished from a tube or pipe intended to transport a fluid.

The fiber according to the invention is manufactured from at least two polymer matrices, one (the first polymer matrix) of which forms the core and the other (the second polymer matrix) of which forms the shell. Other polymer matrices can also be used in the manufacture of the fiber according to the invention. It is thus possible Lo have available a multilayer fiber including solely two layers (the core and the shell) or more than two layers, in the case where one or more other layers are inserted between the core and the shell and/or cover the shell.

The first and/or the second polymer matrix comprise at least one thermoplastic polymer which can be a homopolymer or a block, alternating, random or gradient copolymer. The thermoplastic polymer can be chosen in particular from:
polyamides, such as polyamide 6 (PA-6), polyamide (PA-II), polyamide 12 (PA-12), polyamide 6,6 (PA-6.6), polyamide 4.6 (PA-4,6), polyamide 6.10 (PA-6.10) and polyamide 6.12 (PA-6.12), some of these polymers being sold in particular by Arkema under the name Rilsan® and the preferred ones being those of fluid grade, such as Rilsan® AMNO TLD, and also copolymers, in particular block copolymers, including amide monomers and other monomers, such as polytetramethylene glycol (PTMG) (Pebax®));
aromatic polyamides, such as polyphthalamides;
fluoropolymers chosen from:
(i) those comprising at least 50 mol% of at least one monomer of formula (1):

CFX₁=CX₂X₃ (I)
where X₁, X₂ and X₃ independently denote a hydrogen or halogen atom (in particular a fluorine or chlorine atom), such as poly(vinylidene fluoride) (PVDF), preferably in the a form, poly(trifluoroethylene) (PVF3), polytetrafluoroethylene (PTFE), copolymers of vinylidene fluoride with either hexafluoropropylene (HFP) or trifluoroethylene (VF3) or tetrafluoroethylene (TFE) or chlorotrifluoroethylene (CTFE), fluoroethylene/propylene (FEP) copolymers, or copolymers of ethylene with either fluoroethylene/propylene (FEP) or tetrafluoroethylene (TFE) or chlorotrifluoroethylene (CTFE);
(ii) those comprising at least 50 mol% of at least one monomer of formula (II):

R—O—CH═CH₂ (II)
where R denotes a perhalogenated (in particular perfluorinated) alkyl radical, such as perfluoropropyl vinyl ether (PPVE), perfluoroethyl vinyl ether (PEVE) and copolymers of ethylene with perfluoromethyl vinyl ether (PMVE);
some of these polymers being sold in particular by Arkema under the Kynar® trade name and the preferred ones being those of injection molding grade, such as Kynar® 710 or 720;
polyaryletherketones (PAEKs), such as polyetheretherketone (PEEK) and polyetherketoneketone (PEKK);
poly(vinyl chloride)s:
polyolefins, such as polyethylene (PE) polypropylene (PP) and copolymers of ethylene and of propylene (PE/PP) which are optionally functionalized;
thermoplastic polyurethanes (TPUs);
polyethylene terephthalates or polybutylene terephthalates;
silicone polymers;
acrylic polymers; and
their blends or their alloys.

It is understood that the thermoplastic polymer(s) present in the first polymeric matrix may or may not be chosen from the same family as, indeed even identical to, that or those present in the second polymer matrix.

The first polymer matrix includes, in addition to the abovementioned thermoplastic polymer, nanotubes of at least one chemical element chosen from the elements from Groups IIIa, IVa and Va of the Periodic Table. The polymer matrix advantageously comprises at least one polymer chosen from: PVDF, PA-11, PA-12, PEKK and PE.

These nanotubes, by virtue of their nature and their amount, have to be capable of providing thermal and/or electrical conduction. They can be based on carbon, boron, phosphorus and/or nitrogen (borides, nitrides, carbides, phosphides) and, for example, be composed of carbon nitride, boron nitride, boron carbide, boron. phosphide, phosphorus nitride or carbon boronitride. Carbon nanotubes (hereinafter CNTs) are preferred for use in the present invention.

The nanotubes which can be used according to the invention can be of the single wall, double wall or multiple wall type. Double wall nanotubes can be prepared in particular as described by Flahaut et al. in Chem, Comm. (2003), 1442. For their part, multiple wall nanotubes can be prepared as described in the document WO 03/02456.

The nanotubes usually have a mean diameter ranging from 0.1 to 200 nm, preferably from 0.1 to 100 nm, more preferably from 0.4 to 50 nm and better still from 1 to 30 nm and advantageously a length from 0.1 to 10 μpm. Their length/diameter ratio is preferably greater than 10 and generally greater than 100. Their specific surface is, for example, of between 100 and 300 m²/g and their bulk density can in particular be of between 0.05 and 0.5 g/cm³ and more preferably between 0.1 and 0.2 g/cm³, The multiwall nanotubes can, for example, comprise from 5 to 15 sheets (or wails) and more preferably from 7 to 10 sheets, These nanotubes may or may not be treated.

An example of crude carbon nanotubes is in particular available commercially from Arkema under the trade name Graphistrength® C100.

These nanotubes can be purified and/or treated for example oxidized) and/or ground and/or functionalized, before they are employed in the process according to the invention.

The grinding of the nanotubes can in particular be carried out under cold conditions or under hot conditions and be carried out according to the known techniques employed in devices such as ball mills, hammer mills, edge runner mills, knife mills, gas jet mills or any other grinding systems capable of reducing the size of the entangled network of nanotubes. It is preferable for this grinding stage to be carried out according to a gas jet grinding technique and in particular in an air jet mill.

The crude or ground nanotubes can be purified by washing with a sulfuric acid solution, so as to free them from possible residual inorganic and metallic impurities originating from their process of preparation. The ratio by weight of the nanotubes to the sulfuric acid can in particular be of between 1:2 and 1:3. The purification operation can furthermore be carried out at a temperature ranging from 90 to 120° C., for example for a period of time of 5 to 10 hours. This operation can advantageously be followed by stages of rinsing with water and of drying the purified nanotubes. In an alternative form, the nanotubes can be purified by heat treatment at a high temperature, typically of greater than 1000° C.

The nanotubes are advantageously oxidized by being brought into contact with a sodium hypochlorite solution including from 0.5 to 15% by weight of NaOCl and preferably from 1 to 10% by weight of NaOCl, for example in a ratio by weight of the nanotubes to the sodium hypochlorite ranging from 1:0.1 to 1:1. Oxidation is advantageously carried out at a temperature of less than 60° C. and preferably at ambient temperature, for a period of time ranging from a few minutes to 24 hours. This oxidation operation can advantageously be followed by stages of filtering and/or centrifuging, washing and drying the oxidized nanotubes.

The nanotubes can be functionalized by grafting reactive units, such as vinyl monomers, to the surface of the nanotubes, The constituent material of the nanotubes is used as radical polymerization initiator after having been subjected to a heat treatment at more than 900° C. in an anhydrous and oxygen-free environment, which is intended to remove the oxygen-comprising groups from its surface. It is thus possible to polymerize methyl methacrylate or hydroxyethyl methacrylate at the surface of carbon nanotubes for the purpose of facilitating in particular their dispersion in PVDF or polyamides. In addition, the functionalization of the nanotubes included in the shell of the fiber can improve the attachment thereof to the core of the fiber.

Use is preferably made, in the present invention, of crude nanotubes which are optionally ground, that is to say nanotubes which are neither oxidized nor purified nor functionalized and which have not been subjected to any other chemical and/or heat treatment.

The nanotubes can represent from 0.1 to 30% by weight, preferably from 0.5 to 10% by weight and more preferably still from 1 to 5% by weight, with respect to the weight of the core or shell comprising them.

Another subject matter of the present invention is a process for the manufacture of a fiber as described above and also the fiber capable of being obtained according to this process.

This process comprises a stage of coextrusion of the first and second polymer matrices through a die exhibiting an opening which comprises a first outlet orifice fed by said first polymer matrix and having the shape, in transverse cross section, of said core and a second outlet on fed by said second polymer matrix and having the shape, in transverse cross section, of said shell.

Such a coextrusion process is well known to a person skilled in the art. It generally involves a preliminary stage of introducing and then blending, in a kneading device, for example in an extruder (in particular a corotating twin-screw extruder) or a co-kneader of Buss® type, the respective constituents of the first and second polymer matrices.

The thermoplastic polymers are generally introduced into the kneading device in the granule form or powder form. The nanotubes can be introduced into the same feed hopper as the polymer or into a separate hopper.

The polymer matrices used according to the invention can furthermore comprise at least one adjuvant chosen from plasticizers, antioxidants, light stabilizers, colorants, impact modifiers, antistatic agents (other than the nanotubes), flame retardants, lubricants and their mixtures.

It is preferable for the polymer matrix including the conductive nanotubes (hereinafter conductive polymer matrix) to comprise at least one dispersant intended to improve the dispersing of the nanotubes in this matrix. This dispersant can be a block copolymer as described in the application WO 2005/108485, that is to say a copolymer comprising at least one block 1 carrying ionic or ionizable functional groups, resulting from the polymerization of a monomer Mi representing at least 10% by weight of the block 1 (such as (meth)acrylic acid or maleic anhydride) and of at least one monomer M2 (such as a (meth)acrylate or a styrene derivative), and optionally at least one block 2 compatible with the thermoplastic polymer of the conductive polymer matrix, if the block 1 is not compatible. In an alternative form, the dispersant can be a plasticizing agent which is then advantageously introduced into the kneading device upstream of or in the region of melting of the thermoplastic polymer.

According to one embodiment of the invention, the plasticizer, the thermoplastic polymer and the nanotubes can be introduced simultaneously or successively into the same feed hopper of the mixer. It is generally preferable to introduce all of the plasticizer into this hopper. The abovementioned materials can be introduced successively, in any order, either directly into the hopper or into an appropriate receptacle where they are homogenized before being introduced into the hopper.

In this embodiment, it is preferable for the polymer to be predominantly in the powder form, rather than the granule form. This is because the Applicant Company has demonstrated that this results in a better dispersion of the nanotubes in the polymer matrix and in a better conductivity of the conductive matrix obtained. In practice, use may be made of a blend of polymer in the powder form and of polymer in the granule form, in a ratio by weight of the polymer in the powder form to the polymer in the granule form ranging from 70:30 to 100:0 and more preferably from 90:10 to 100:0.

This embodiment of the invention is well suited to solid plasticizers. The latter can optionally be introduced into the feed hopper of the mixer in the precomposite form with the nanotubes. Such a precomposite, including 70% by weight of poly(butylene terephthalate) cyclized as plasticizer and 30% by weight of multiwall nanotubes, is, for example, available commercially from Arkema under the trade name Graphistrength® C M12-30.

This embodiment of the invention can, however, also be employed in the case where the plasticizer is in the liquid state, In this case, the nanotubes and the plasticizer can be introduced into the hopper or the abovementioned receptacle in the precomposite form. Such a precomposite can, for example, be obtained according to a process involving:
1-bringing a plasticizer in the liquid form, optionally in the molten state or in solution in a solvent, into contact with the powdered nanotubes, for example by dispersion or direct introduction by pouring the plasticizer into the nanotube powder (or the reverse), by dropwise introduction of the plasticizer into the powder or by spraying the plasticizer over the nanotube powder using a sprayer, and
2-drying the precomposite obtained, optionally after removing the solvent (typically by evaporation).

The first stage above can be carried out in conventional synthesis reactors, blade mixers, fluidized bed reactors or mixing devices of Brabender, Z-arm mixer or extruder type. It is generally preferable to use a conical mixer, for example of Vrieco-Nauta type from Hosokawa, comprising a rotating screw which goes round along the wall of a conical vessel.

In an alternative form, a precomposite can be formed from the liquid plasticizer and the thermoplastic polymer, before mixing with the nanotubes.

In all cases, the conductive polymer matrix obtained is introduced into a coextrusion die with the other polymer matrix not comprising the nanotubes.

This die can exhibit first and second outlet orifices of any shape and arrangement, respectively for the first and second polymer matrices, provided that the second polymer matrix at least partially forms a shell round the first polymer matrix. In a first alternative form of the invention, the first and second orifices are concentric. In this case, the second orifice can be positioned over the entire periphery of the first orifice or over a portion only of the periphery. In a second alternative form, the second orifice can be positioned partially at the periphery of the first orifice and partially through the first orifice. The first orifice can thus assume the shape of two half moons, for example. In addition, the core of the fiber according to the invention can assume, in transverse cross section, a circular, elliptical, square, rectangular, triangular or multilobate shape. Recourse to a multilobate shape makes it possible in particular, during the subsequent weaving of the fibers, to connect the surface lines of the fibers.

After this coextrusion stage, the process according to the invention can furthermore comprise an additional stage which consists in drawing the fibers obtained, at a temperature greater than the glass transition temperature (Tg) of the thermoplastic polymer of the nonconductive matrix and optionally greater than the Tg of the thermoplastic polymer of the conductive polymer matrix and preferably less than the melting point of the thermoplastic polymer of the nonconductive matrix. In addition, this drawing stage can optionally be carried out at a temperature greater than the melting point of the thermoplastic polymer of the conductive polymer matrix, in order to improve its conductive properties. The drawing stage, described in the patent U.S. Pat. No. 6,331,265, which is incorporated here by reference, makes it possible to orientate the nanotubes and the polymer substantially in the same direction, along the axis of the fiber, and to thus improve the mechanical properties of the latter, in particular its tensile modulus (Young's modulus) and its tenacity (fracture strength), The draw ratio, defined as the ratio of the length of the fiber after drawing to its length before drawing, can be of between 1 and 20, preferably between 1 and 10, limits included. The drawing can be carried out just once or several times, the fiber being allowed to relax slightly between each drawing operation. This drawing stage is preferably carried out by passing the fibers over a series of rolls having different speeds of rotation, those which reel off the fiber rotating at a slower speed than those which receive it. In order to achieve the desired drawing temperature, it is possible either to pass the fibers through ovens positioned between the rolls, or to use heated rolls, or to combine these two techniques.

In addition, although the multilayer conductive fibers obtained according to this process are intrinsically conductive, that is to say that the conductive polymer matrix exhibits a resistivity which can be less than 10⁵ ohm.cm at ambient temperature, the electrical conductivity of these fibers can be further improved by heat treatments.

The multilayer conductive fibers according to the invention can be used in the manufacture of noses, wings or cabins of rockets or aircraft; of offshore flexible pipe reinforcements; of automobile body or engine chassis components or of support parts for the automobile; of automobile seat coverings; of structural components in the construction or civil engineering field; of antistatic wrappings and textiles, in particular of antistatic curtains, of antistatic clothing (for example, for safety or for clean rooms) or of materials for the protection of silos or the packaging and/or transportation of powders or granular materials; of furniture components, in particular of furniture for clean rooms; of filters; of electromagnetic shielding devices, in particular for the protection of electronic components; of heated textiles; of conducting cables; of sensors, in particular mechanical strain or stress sensors; of electrodes; of hydrogen storage devices; or of biomedical devices, such as suture threads, prostheses or catheters.

These composite parts can be manufactured according to various processes, generally involving a stage of impregnation of the fibers with a polymer composition including at least one thermoplastic, elastomeric or thermosetting material. This impregnation stage can itself be carried out according to various techniques, depending in particular on the physical form of the composition used (pulverulent or more or less liquid). The impregnation of the fibers is preferably carried out according to a fluidized had impregnation process, in which the polymer composition is in the powder form. In addition, it is preferable for the impregnation polymer matrix to comprise at least one of the thermoplastic materials used for the manufacture of the multilayer conductive fibers according to the invention.

Semi-finished products are thus obtained which are subsequently used in the manufacture of the desired composite part. Various preimpregnated fabrics formed of fibers, identical or different in composition, can be stacked to form a laminated sheet or material or, in an alternative form, subjected to a thermoforming process. In an alternative form, the fibers can be combined to form strips which are capable of being used in a filament-winding process which makes it possible to obtain hollow parts of virtually unlimited shape, by winding strips around a mandrel having the shape of the part to be manufactured. In all cases, the manufacture of the finished part comprises a stage of consolidation of the polymer composition, which is, for example, locally melted to create regions of attachment of the fibers to one another and/or to render integral the strips of fibers in the filament-winding process.

In another alternative form, it is possible to prepare a film from the impregnation composition, in particular by means of an extrusion or a calendaring process, said film having, for example, a thickness of approximately 100 μm, and then to place it between two mats of fibers according to the invention, the combination then being hot-pressed in order to make possible the impregnation of the fibers and the manufacture of the composite,

In these processes, the multilayer fibers according to the invention can be woven or knitted, alone or with other fibers, or can be used, alone or in combination with other fibers, in the manufacture of felts or nonwoven materials. Examples of constituent materials of these other fibers comprise, without limitation:
drawn polymer fibers, in particular based: on polyamide, such as polyamide 6 (PA-6), polyamide 11 (PA-11), polyamide 12 (PA-12), polyamide 6.6 (PA-6.6), polyamide 4.6 (PA-4.6), polyamide 6.10 (PA-6.10) or polyamide 6.12 (PA-6,12), on polyamide/polyether block copolymer (Pebax®), on high-density polyethylene, on polypropylene or on polyester, such as polyhydroxyalkanoates and the polyesters sold by Du Pont under the Hytrel® trade name;
carbon fibers;
glass fibers, in particular of type E, R or S2 glass;
aramid (Kevlar®) fibers;
boron fibers;
silica fibers;
natural fibers, such as flax, hemp, sisal, cotton, wool or silk; and
their mixtures, such as mixtures of glass, carbon and aramid fibers.

Another subject matter of the invention is thus a composite material comprising multilayer composite fibers as described above, bonded to one another by weaving or using a polymer matrix

1. A multilayer conductive fiber, comprising:
a core composed of a first polymer matrix including at least one thermoplastic polymer and a dispersion of nanotubes of at least one chemical element selected from the group consisting of elements from Groups IIIa, IVa and Va of the Periodic Table, said nanotubes providing thermal and/or electrical conduction,
a shell composed of a second polymer matrix including at least one thermoplastic polymer other than poly(vinyl alcohol) said shell free of a dispersion of nanotubes of at least one chemical element selected from the group consisting of elements from Groups IIIa, IVa, and Va of the Periodic Table.

2. The fiber as claimed in claim 1, characterized in that the core of the multilayer conductive fiber forms a solid structure,

3. The fiber as claimed in claim 1, characterized in that the nanotubes are carbon nanotubes.

4. The fiber as claimed in claim 1, characterized in that the thermoplastic polymer of the first polymer matrix and/or of the second polymer matrix is selected from the group consisting of:
polyamides selected from the group consisting of polyamide 6, polyamide 11, polyamide 12, polyamide 6.6, polyamide 4.6, polyamide 6.10 and polyamide 6.12-copolymers including amide monomers;
aromatic polyamides;
fluoropolymers selected from the group consisting of:
(i) first fluoropolymers comprising at least 50 mol% of at least one monomer of formula (I):
CFX₁═CX₂X₃ (I)
where X₁, X₂ and X₃ independently denote a hydrogen or halogen;
(ii) second fluoropolymer comprising at least 50 mol% of at least one monomer of formula (II):
R—O—CH═CH₂ (II)
where R denotes a perhalogenated alkyl radical;
polyaryletherketones;
poly(vinyl chloride)s:
polyolefins;
thermoplastic polyurethanes;
polyethylene terephthalates or polybutylene terephthalates;
silicone polymers;
acrylic polymers; and
mixtures thereof.

5. The fiber as claimed in claim 4, characterized in that the polymer matrix including the nanotubes comprises at least one polymer selected from the group sonsisting of PVDF, PA-11, PA-12, PEKK and PE.

6. The fiber as claimed in claim 1, characterized in that the core including the nanotubes comprises from 0.1 to 30% by weight of nanotubes.

7. A process for the manufacture of a fiber as claimed in claim 1, characterized in that it comprises coextruding said polymer matrices through a die exhibiting an opening which comprises a first outlet orifice fed by said first polymer matrix and having the shape, in transverse cross section, of said core and a second outlet orifice fed by said second polymer matrix having the shape, in transverse cross section, of said shell.

8. The process as claimed in claim 7, characterized in that the core has, in transverse cross section, a circular, elliptical, square, rectangular, triangular or multilobate shape.

9. The process as claimed in claim 7, characterized in that the second orifice is positioned partially at the periphery of the first orifice and partially through the first orifice.

10. The process as claimed in claim 7, characterized in that the first and second orifices are concentric.

11. A multilayer conductive fiber obtained according to the process as claimed in claim 7.

12. (canceled)

13. A composite material comprising multilayer composite fibers as claimed in claim 11, bonded to one another by weaving or using a polymer matrix.

14. The fiber as claimed in claim 4, characterized in that said first fluoropolymer is selected from the group consisting of poly(vinylidene fluoride), poly(trifluoroethylene), polytetrafluoroethylene, copolymers of vinylidene fluoride with hexafluoropropylene or trifluoroethylene or tetrafluoroethylene or chlorotrifluoroethylene, fluoroethylene/propylene copolymers, copolymers of ethylene with fluoroethylene/propylene or tetrafluoroethylene or chlorotrifluoroethylene.

15. The fiber as claimed in claim 4, characterized in that said perhalogenated alkyl radical is selected from the group consisting of perfluoropropyl vinyl ether, perfluoroethyl vinyl ether and copolymers of ethylene with perfluoromethyl vinyl ether.
